(19) United States
(12) Patent Application Publication
(10) Pub. No.: US 2011/0055312 A1
(43) Pub. Date: Mar. 3, 2011

(54) CHUNKED DOWNLOADS OVER A CONTENT DELIVERY NETWORK

(75) Inventor: Gregor N. Purdy, SR., Morgan Hill, CA (US)

(73) Assignee: Apple Inc., Cupertino, CA (US)

(21) Appl. No.: 12/550,190

(22) Filed: Aug. 28, 2009

(51) Int. Cl. G06F 15/16

(52) U.S. Cl. 709/203; 709/230

(57) ABSTRACT

A file is downloaded from a Content Delivery Network (CDN) in a series of byte ranges or chunks collectively making up the entire file. A client computer can request a file from a CDN by first requesting a server address, from a domain name server (DNS), which can facilitate the downloading of a file in chunks, by returning more than one server to service the download request. Alternatively, the DNS server can instruct the client to request each byte range of the file individually from the DNS server so that it can individually direct the request to the most preferable server. Alternatively the server returned by the DNS can redirect requests for a series of ranges to other servers to service the series of byte ranges simultaneously.

### TECHNICAL FIELD

The present technology relates to downloading a file from a content delivery network and is more specifically directed to simultaneously downloading a plurality of byte ranges, collectively making up an entire file, from a content delivery network.

### BACKGROUND

The Internet is frequently used to distribute media, software, applications, and other files and content. Companies and other content providers offer various files for download. For example in the entertainment industry, customers can purchase music or movies to download onto their computers. In the software industry, customers and users can purchase software and/or upgrades to download onto their computers. However, in order for customers and users to download such files, the files must be hosted online. It is common for a provider to host the content it provides. However, if a provider hosts a popular file which numerous users want to download, the provider's web server (which carries out the actual transmission of the requested data to the users) can become slow due to all the numerous requests and transmissions. Therefore, it is becoming more common for providers to use a Content Delivery Network (CDN), such as Akamai, to distribute their files.

A content provider makes files available for download via the CDN by uploading them to CDN server(s) or by configuring the CDN to fetch them from the content provider as needed. The CDN usually has multiple web servers across various locations, where each web server caches, stores, or somehow has access to the file(s) uploaded by the provider. While the particular protocols involved could change over time, in current practice, a user's request to download a file from the content provider is processed by the CDN according to the following steps: First, the user's computer makes a standard Domain Name Service (DNS) query to look up the Internet Protocol (IP) address of the host for the file. DNS servers operated by the CDN handle this DNS query. The CDN then determines from which one of its web servers, instead of from the content provider's web server, the user should download the file. Second, the CDN responds to the DNS query with the IP address of the chosen host. Third, software on the user's computer then downloads the entire file from that single CDN web server. However, downloading the entire file from a single web server in the CDN has its disadvantages.

Unlike in a CDN, in a Peer-To-Peer (P2P) file-sharing network, users try to download files from each other in chunks. In a P2P network, each user can typically find multiple sources (peers) from which to download different chunks of the requested file. Therefore, even if one of the P2P sources becomes slow during the lifetime of the download, the overall transmission to the user is not significantly affected. However in a CDN, since the user typically downloads the entire file from a single web server, if that web server becomes slow (due to high workload, network congestion, etc.), the download will be significantly affected (slowed or even lost). Furthermore, in a P2P network other available sources (peers) are utilized to facilitate the download, whereas in a CDN other suitable web servers are typically not utilized. In this way, the load is spread out and balanced in the P2P network, whereas the CDN does not implement this. Nonetheless, P2P networks also have disadvantages. Companies and other content providers are hesitant to utilize P2P networks to distribute their content due to the negative stigmas associated with P2P networks. In a P2P network, there is less control over the distribution of the content (for example, any peer can share the content with another peer), which can lead to unauthorized uses of the content (piracy, illegal copying, etc.). In addition, a user cannot use a P2P network unless he/she downloads additional specific client software to connect to the respective specific P2P network, thereby making use of the P2P network less transparent on user-side.

A need exists for a solution to allow a CDN to provide the segmented downloading of files in a way that can improve overall download speed.

### SUMMARY

Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

The present disclosure describes computer implemented methods and arrangements for delivering a file in chunks from a Content Delivery Network (CDN). Herein disclosed are embodiments for modifying existing CDN systems or existing software on client devices to download files from a CDN by simultaneously downloading ranges of bytes that make up a file.

In some embodiments clients will utilize an existing domain name service (DNS) of a CDN to request an IP address of a named server in a conventional A-record, and thereafter request ranges of bytes making up a file from the returned IP address. In such embodiments, client devices are configured to make repeated requests of the of the CDN end server identified by the IP address for byte ranges of a desired file and are further configured to receive a download as chunks of a file to be reassembled by the client computer.

In some embodiments, the DNS has been configured to receive and return a new type of DNS entry comprising a list of IP addresses mapping to CDN end servers candidates to serve a requested download. In these embodiments a client can request a multi-IP address lookup from the DNS and the DNS can return a “chunk-record” having a list of all IP addresses of servers that map to a named server. The client can thereafter utilize the information in the chunk-record to request ranges of bytes from the servers identified therein. Once again the client is configured to make multiple requests for ranges of bytes comprising a file and can receive a download as chunks of a file to be reassembled by the client computer.

In some embodiments, the DNS can return a conventional A-record, but with various controls attached to the A-record. For example, in these embodiments the DNS may return an A-record with a short time-to-live (TTL), or other instructions to limit the use of the A-record. A client can request the IP address of a named server and the DNS can return an A-record comprising this information along with a sufficiently short TTL such that it is only useful to make one request of an identified server. Using this method, a client attempting to download a file in chunks will request the first chunk from the end server identified in the A-record, but for subsequent chunks, the client will need to re-request an IP address of a server to service the next range of bytes making up the file. In this way, the system can repeatedly take advantage of the intelligent routing capabilities common within DNS servers and balance the load of the plurality of chunked requests for a given file across server CDN end servers.

In some embodiments, the CDN web servers can be utilized to route the download requests across multiple servers. In these embodiments, the DNS server can take on the characteristics described for any of the other described embodiments. The client will continue to make requests for a desired file in ranges of bytes, but the CDN web servers can receive the download requests and optionally service the request or redirect the request to another server within the CDN. In this way, the CDN web server is endowed with similar routing logic as that of a DNS and can thus load balance the series of requests across multiple servers.

Across the embodiments herein described, the DNS server can have varying degrees of control logic. For example, and separate from or in addition to the short TTL embodiments, the DNS can also return information such as limits on number of requests for any given server, rankings of most optimum servers, limits on byte ranges that can be accommodated, and other control logic that may be useful in carrying out the described embodiments.

Further, the client computers described in the various embodiments can be configured to utilize optimization logic for selecting which servers to request byte ranges from, how many simultaneous requests, size or requests and other such logic for selecting various optimization parameters. Client computers can also be configured to request a file size before requesting ranges of bytes making up the file.

Also disclosed are various devices, such as client devices, components of a CDN network that are useful or necessary for carrying out the described embodiments. Further, systems of devices and components are also described. Similarly, the described embodiments can all be recorded on a computer programmable product having computer readable instructions stored thereon and useful for instructing various processor-based devices for carrying out the methods described herein.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an example computing device;

FIG. 2 illustrates an example system embodiment;

FIG. 3 illustrates a method embodiment for processing a request for file download from a given address;

FIG. 4 illustrates a method embodiment for processing a request for file download from a given address;

FIG. 5 illustrates a method embodiment for processing a request for file download from a given address;

FIG. 6 illustrates an example system embodiment;

FIG. 7 illustrates a method embodiment of an end server redirecting embodiment;

FIG. 8 illustrates a system embodiment of an end server redirecting embodiment; and

FIG. 9 illustrates an intelligent routing embodiment of a server.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

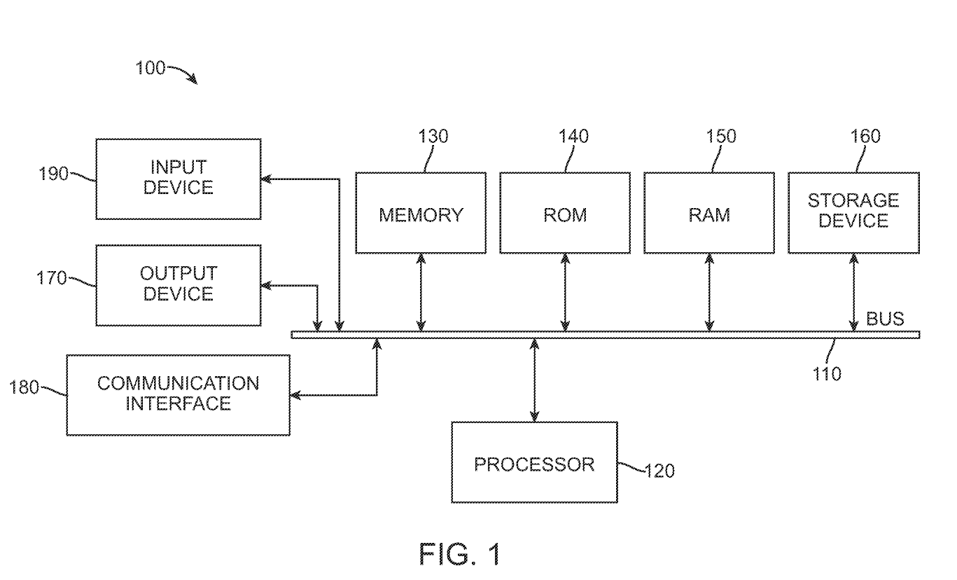

With reference to FIG. 1, a general-purpose computing device 100 which can be portable or stationary is shown, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the system may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a large computer server.

Although the exemplary environment described herein employs a hard disk, it should be appreciated by those skilled in the art that other types of computer readable media which can store data that is accessible by a computer, such as magnetic cassettes, flash memory cards, digital versatile disks, cartridges, random access memories (RAMs), read only memory (ROM), may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. For example, video output or audio output devices which can be connected to or can include displays or speakers are common. Additionally, the video output and audio output devices can also include specialized processors for enhanced performance of these specialized functions. In some instances, multimodal systems enable a user to provide multiple types of input to communicate with the computing device 100. The communications interface 180 generally governs and manages the user input and system output. There is no restriction on the disclosed methods and devices operating on any particular hardware arrangement and therefore the basic features may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

The present system and method is particularly useful for distributing a file in chunks to a user via a Content Delivery Network (CDN). At a high level a client computer can be configured to request files to be downloaded in ranges or chunks. For example, a 10-megabyte file can be downloaded in ranges of bytes 1-3,000,000 and 3,000,001-6,000,000 and 6,000,001-10,000,000 to provide a download in three different chunks. A file can be divided into any number of chunks of any range of bytes in order to maximize efficiency and speed of download.

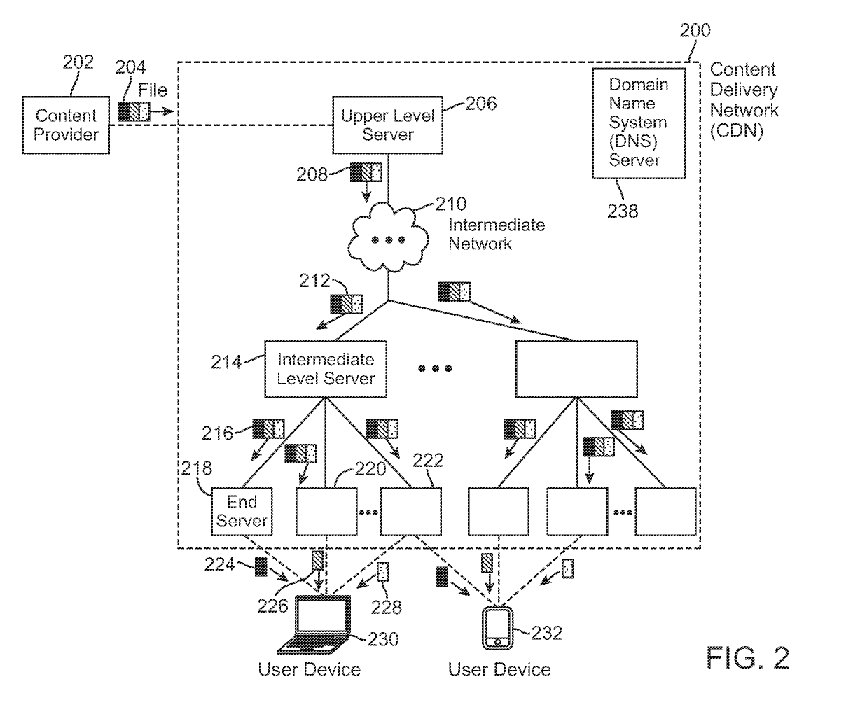

A CDN 200 for servicing chunked download requests is illustrated in FIG. 2 wherein at least one end server 218, 220, 222 of the CDN is capable of providing a chunk 224, 226, 228 of a requested file 204 for download to a client device 230, 232. In some embodiments the present system and method are carried out via Internet connections however, the present principles are applicable to a wide variety of networks that facilitate the intercommunication of electronic devices.

A content provider 202 can provide a file 204 to a CDN 200 to host for a user or client for download. The content provider 202 communicates with the CDN 200 in order to transmit the file 204 to be downloaded to the CDN. This communication may or may not be conducted over the Internet. An upper-level/root/parent server 206 of the CDN distributes the file 208, 212, 216 throughout the CDN, where there may or may not be an intermediate network 210 and/or intermediate-level servers 214 within the CDN. Any of the servers 206, 210, 214, 218, 220, 222 on any of the levels within the CDN can be implemented with a computing device. By distributing the file 204 throughout the network, a greater number of servers exist to service requests for a given file. Additionally, because there are numerous servers to service the request, they can be geographically distributed so that the servers can be relatively local, geographically, to various clients requesting files for download.

End servers 218, 220, 222 service download requests by delivering the file to the client requesting the file. In the embodiment shown in FIG. 2, multiple end servers 218, 220, 222 are servicing the request for the downloaded file 204 in chunks 224, 226, 228. End server 218 sends chunk 224 to client 230, while server 220 sends chunk 226 and server 222 sends chunk 228. User device 232 is also shown receiving a file in chunks from multiple end servers.

Also shown in FIG. 2 is a domain name service (DNS) 238, which is part of the CDN 200. A DNS receives a request for an IP address based on a URL provided by a client and returns a DNS address record (A-record) identifying the IP address of an end server to service a download request. The client uses the returned IP address to contact the end server directly. As is known in the art, the DNS can determine which end server should service the request based on network efficiency parameters such as geographic proximity to the source of the request, bandwidth, network congestion and other parameters that can be used to identify the end server that can most efficiently service the request. In other words, the DNS can intelligently route download requests by returning the IP address of the end server that can most efficiently service a download request to the client.

In some embodiments the DNS returns the IP address of an end server based on parameters other than network efficiency parameters. For example, in some embodiments, the DNS can return the IP address of an end server that is different than an address recently returned to the same client computer.

In some embodiments the DNS has been further modified to accept requests for a new type of DNS record, a chunk-record, which contains a list of IP addresses corresponding to several end servers that can potentially service a download request.

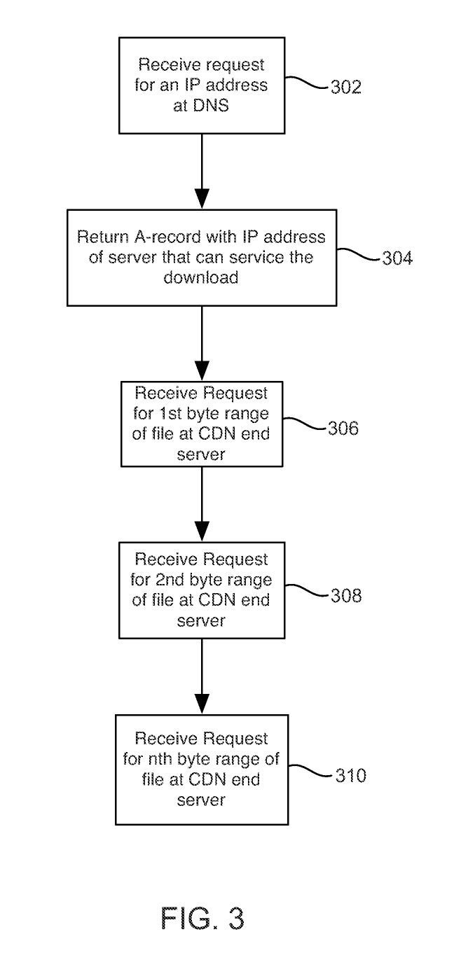

FIGS. 3-5 illustrate the embodiments of the described system relying on the DNS to provide the client with an IP address of an end server that will service the download request. For example in FIG. 3, a conventional DNS receives a request for an IP address 302 corresponding to a supplied URL and returns an A-record having an IP address 304 mapping to a CDN end server that can service the request. As discussed above the DNS can select the appropriate end server based on information regarding network efficiencies and information relevant to the content delivery network. Using the returned IP address, the client requests a first range of bytes making up a portion of a desired file and the CDN end server receives and services the request 306. At the same time, or at nearly the same time, the client requests a second byte range 308 from the same server and continues to request additional byte ranges 310 until all byte ranges have been requested or the entire file has been downloaded. In some embodiments, the client can also repeat the process starting at 302 for any new range of bytes.

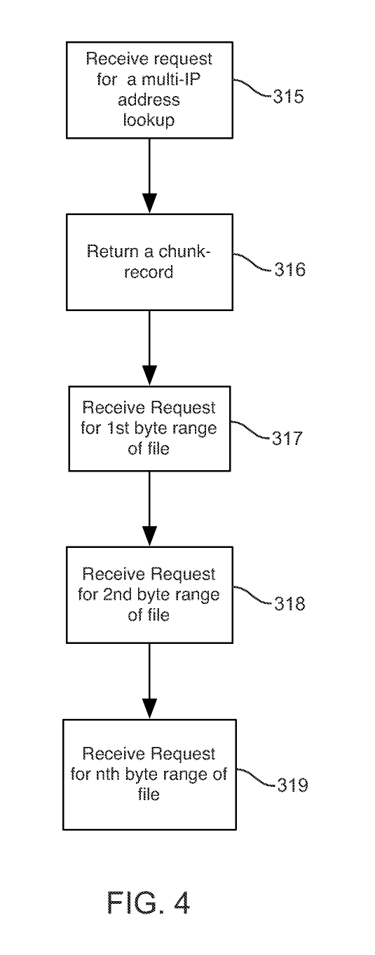

FIG. 4 illustrates embodiments wherein the DNS can be modified to return a new type of record having the IP addresses of several CDN end servers that can service a download request, hereinafter, a chunk-record. A client can send and the DNS receives a request for a multi-address lookup corresponding to a given URL 315. In response to the request 315 the DNS can return a chunk-record comprising a list of servers available to service the request 316. Using this list of servers the client can make a plurality of requests that are received by the CDN 317, 318, 319. Each of the requests can be for separate or overlapping ranges of bytes that comprise the entire file. Each request can be sent to the same CDN end server, but preferable the requests will be distributed among the servers corresponding to the list of IP addresses contained in the chunk-record.

In these embodiments it is the client device that ultimately decides from which end server, represented in the chunk-record, to request the range of bytes. The client can make this selection using a round-robin type selection process wherein the client can make requests from the servers identified in the chunk-record in a rotation. Alternatively, the client can randomly select an IP address from the list for any given request for a range of bytes. However, in some embodiments the client can have a somewhat intelligent system wherein the client can select a server identified within the chunk-record based on optimization logic. For example, the client can monitor the download speeds from requests from the various IP addresses and reuse the best performing servers more often. The client can also monitor the downloads already requested to determine whether it is receiving any benefit from making multiple requests from the same server, and make new requests of that server accordingly. Other optimization logic can also be used to choose from which IP addresses to request the chunks of a file to be downloaded. Further, it should be appreciated that one or more features described above can be useful outside of the exemplary embodiments and these features should not be considered specific to this embodiment.

In some embodiments the chunk-record returned at 316 can also include additional information about the servers listed in the record. For example, the special A-record can also include rankings of the servers indicating which server is the best suited to service a request. The chunk-record can also include information about how big of a range of bytes should optimally be requested from a particular server. Other information can also be useful and can be included in the chunk-record such as information descriptive of the location of the user device, information descriptive of network congestion on the CDN end servers, information descriptive of the amount of requests to be serviced by the CDN end servers, etc.

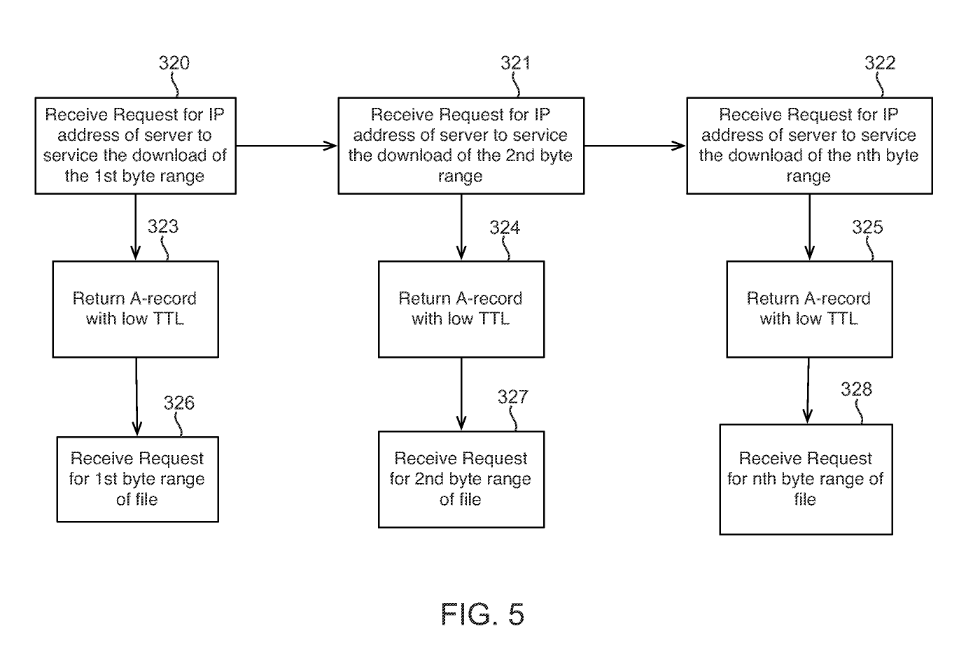

FIG. 5 illustrates embodiments wherein the DNS server returns a conventional A-record with a very low time to live (TTL). The DNS receives a request 320 for an IP address from a client and the DNS returns an A-record to the client having a low TTL 323. The TTL should be short enough so that any record returned to the client will only live (be useful) long enough to connect to the returned IP address once. Accordingly the TTL should be less than a minute and more preferably less than a second. In some embodiments the TTL is less than 100 milliseconds. When the client receives the A-record with a low TTL, the client requests the first range of the file from the IP address identified in the A-record at 326. The end server within the CDN can then begin servicing that request. In the meantime, possibly while 320, 323 and 326 are being carried out, the client can request the second chunk of the file from the DNS 321 that will recalculate the best server to fill the request and return the IP address of that server in another A-record with a short TTL in 324. Next, the client can request the second chunk from the server identified in the A-record to service the request at 327. The method can continue until all chunks are requested or downloaded. For example, while the first and second chunks are downloading the method continues in an iterative fashion, requesting additional ranges of bytes 322, receiving A-records with a low TTL 325 and requesting the next chunk from the server identified in the A-record 328.

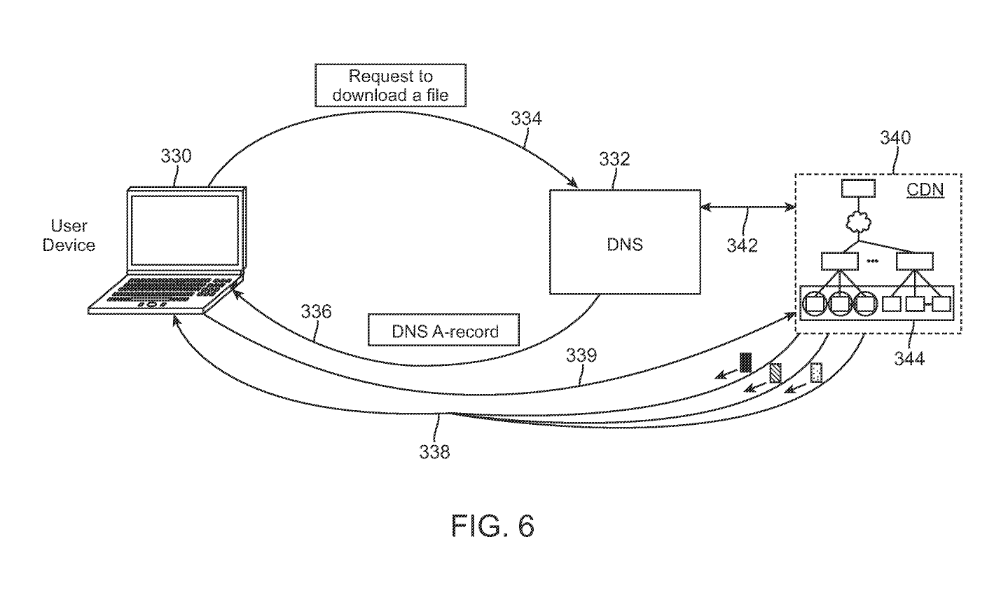

FIG. 6 illustrates a system embodiment. A client device 330 requests an IP address corresponding to a named server to provide a file for download 334 from a DNS server 332. The DNS server 332 is in communication 342 with the other computers of the CDN 340 to monitor their ability to processes additional requests, ability to handle ranged requests, network congestion and other factors that are helpful in intelligently routing requests to the end servers 344 that can most efficiently service the request. The DNS 332 communicates 336 the IP address of one or more end servers to the client. The client requests 339 the file in chunks from the CDN 340 and receives the chunks of the file in a series of two or more communications 338.

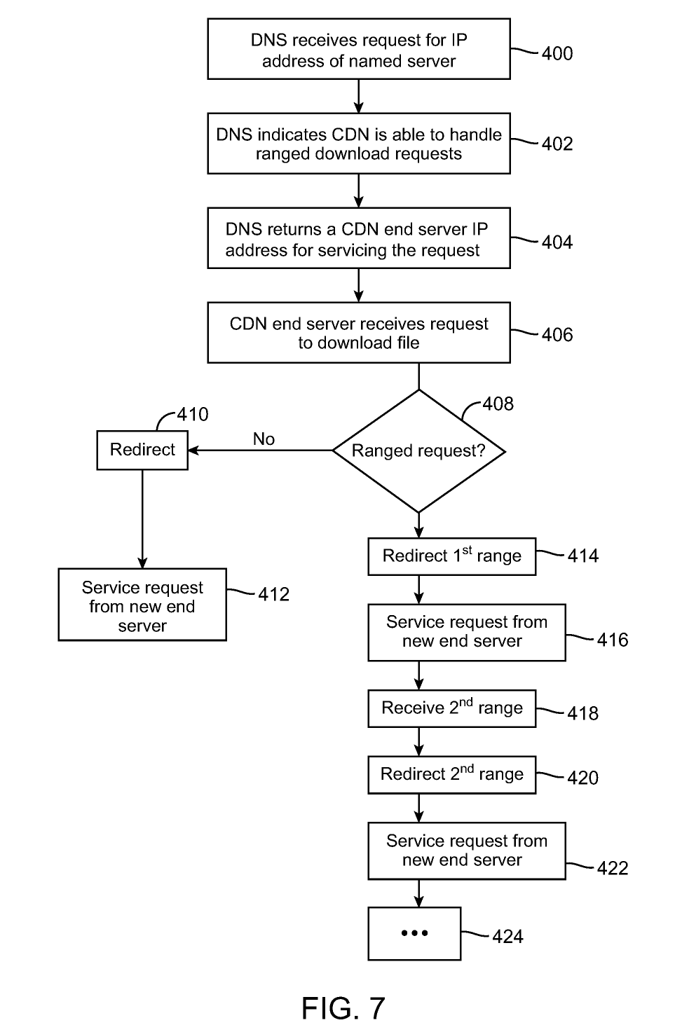

FIG. 7 illustrates a method of carrying out embodiments utilizing end servers of the CDN to facilitate downloading of files in chunks by allowing the end server to redirect download requests. In these embodiments each CDN end server can have access to information descriptive of the location of the user device, information descriptive of other CDN end servers' workload, availability, network congestion, etc. In other words, the CDN end server is configured to have similar intelligent routing abilities as a DNS server.

As illustrated in FIG. 7, the DNS server receives a request for the IP address of a named server from a client 400. The DNS server optionally notifies the client that the CDN is capable of servicing chunked downloading 402 and returns a first IP address of an end server for servicing a file download request 404. When the first end server receives the request to download a file 406, that end server processes the request to determine whether the request is a ranged request 408. If the request is a request to download the entire file, the first end server can redirect the request 410 to a second end server to service the request 412. The second end server is chosen by the first end server based on the first end server's intelligent routing (similar to DNS capabilities, described above) capabilities, which can identify the second end server as being better able to handle the request. However, in some embodiments the first end server can also determine that it is best suited to service the request and then service the request itself.

Returning to 408, if the request is a ranged request, the first end server can assume that additional requests are forthcoming and use its intelligent routing capabilities to select a server to service the current portion of the ranged request and redirect the client to that server 414. The end server to which the client was redirected can then service the request 416. At the same time, the first end server can also be receiving the second or next range of bytes 418 for the requested file and redirect 420 that request to the same or different server than any of the previous ranges to be serviced by that server 422. The process of receiving a request for a range of bytes and redirecting the request to a new server and servicing that request can continue 424 until all bytes are either being serviced or have been downloaded.

In some embodiments the first end server to receive a request can service the request itself. This can be desirable if the first end server determines that it is the best suited to service the request. In some embodiments, some end servers are programmed to always service requests and to never redirect to prevent endless redirecting. In still some embodiments, the number of times a request is directed is recorded and a limit is placed on the number or redirects that are allowed. In such embodiments any server receiving a redirected request that has already exceeded the limit for the number of redirects that are allowed must service the request.

The process of redirecting can be by any processes known in the art, for example, by passing off the request or by instructing the client to request the bytes again.

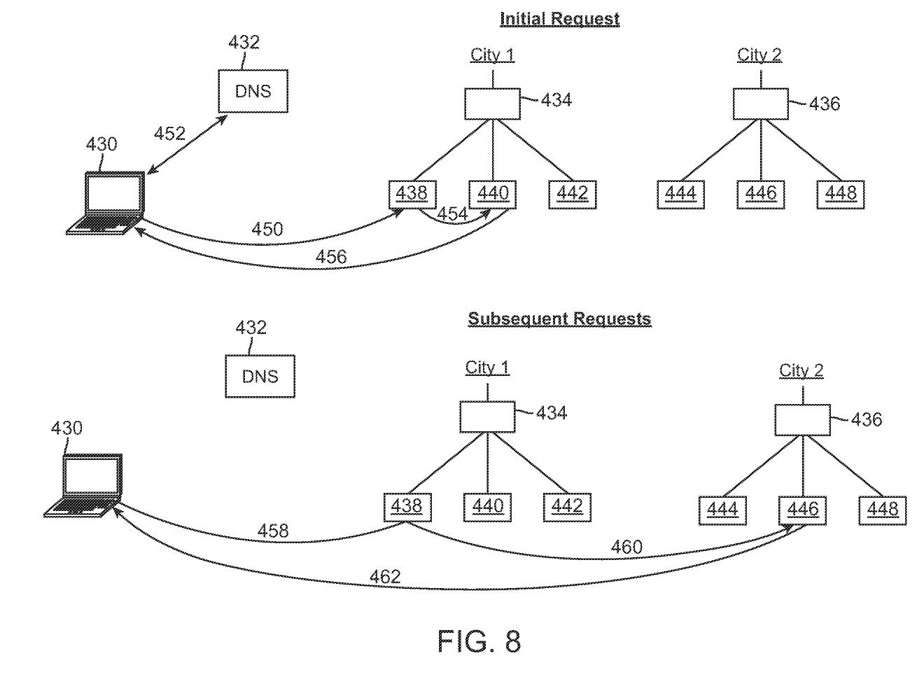

FIG. 8 illustrates a system embodiment of the end server redirecting embodiments. The figure illustrates a portion of a CDN wherein two branches of the CDN are located in different cities. Intermediate servers 434 and 436 receive files from the rest of the network and distribute them to the end servers in the same city. As illustrated, server 434 can distribute files to end servers 438, 440, 442, all of which are located in City 1. Likewise server 436 can distribute files to end servers 444, 446, 448, all of which are located in City 2.

For the initial request of the first range of bytes comprising the file to be downloaded, the client computer 430 requests an IP address from DNS 432 and the DNS returns the IP address of a nearby end server in the form of an A-record to process the request. The communication between client 430 and the DNS 432 is shown as 452.

Client 430 then makes a ranged request 450 of end server 438 using the IP address given to client 430 by DNS 432 to locate the end server 438. Instead of serving the request itself, end server 438 determines that end server 440 is better able to service the request and redirects 454 client computer 430 to end server 440 which then services the request 456.

When the client computer 430 makes any subsequent request it is not necessary to again query the DNS 432 since the client computer can cache the A-record previously received. However, in some embodiments further communication between the client 430 and the DNS 432 can take place. For example if the A-record has a short TTL or the subsequent request comes long after the original request additional communication with the DNS will be desired.

However, assuming no communication with the DNS is desired or needed, the client 430 sends 458 subsequent ranged requests to the end server identified in the A-record, in this case end server 438. End server 438 once again calculates the best end server to service the request and determines that server 446 is the best server. Notice server 446 can be selected even though it is in a different city. End server 438 redirects 460 the request to server 446, which services the request 462.

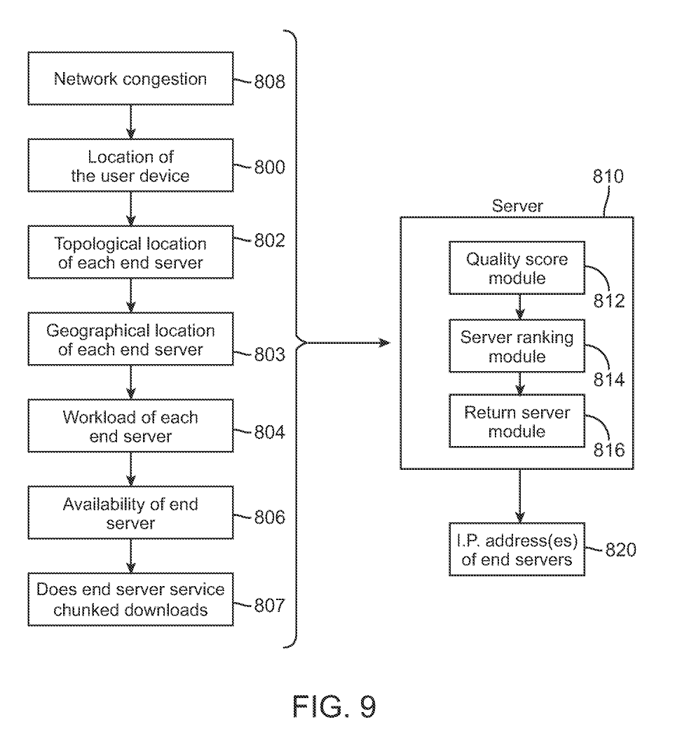

FIG. 9 illustrates a method of determining the best end server to serve a chunked request. As mentioned above, this determination can be performed by a DNS server and/or by a CDN end server. To intelligently route received download requests, the DNS or end server receives and processes a plurality of inputs including, but not limited to, whether an end server handles chunked requests 807, the location of the user device 800, the location of each end server topologically neighboring (or near) the user device 802, the geographic proximity of the end server to the client 803, the workload of each end server near the user device 804, the availability of each end server near the user device 806, the network congestion 808, etc. Based on these inputs, a quality score representing the ability for an end server to service a specific request for a particular file is calculated for each of the available end servers 810. It might not be the case that the end server closest to the user device is the most desirable server to service a request. For example, a more geographically proximate end server can be deemed less desirable to service a request than an end server further removed from the client device requesting the download if more proximate server had a higher workload or were unavailable. A ranked list can be generated based on the quality scores, 812. The DNS server or end server returns 820 via the return server module 816 to the client the IP address of at least one end server having a relatively high quality score as determined by the server ranking module 814.

In some embodiments the end server can also be configured to determine whether it or other end servers are the most desirable server to service a request using the same technique. In which case the end server can return quality scores for other end servers and based on those scores the end server can either service the request itself or redirect the client to a more desirable end server.

With regard to the embodiments described herein, the user side can also possess special functionalities in order to handle chunking appropriately. If the user side does not have the functionalities to handle chunked downloading, it will merely download the file in a non-chunked fashion (for example, the user device downloads the entire file from one end server in the CDN). The special functionalities can be implemented via download managing software, which the user would have to acquire, or via web browsers with built-in capabilities to handle chunked downloading. One special functionality can be having the ability to request and use a chunk-record sent by the DNS server CDN. In addition, a key functionality on the user side is the ability to process downloaded chunks of the file and recombine them to form the original file.

While the methods illustrated and described above may have been described as separate embodiments, it should be appreciated that elements of each embodiment can be applied in the others and thus, they should not be considered exclusive of each other.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present disclosure.

1. A method for delivering a file in chunks from a Content Delivery Network comprising:
receiving a DNS request, from a client, at a domain name service (DNS) for an IP address of a server from which the client can download a file in chunks;
processing the DNS request to determine an address of the server of the Content Delivery Network to service the request;
returning the address of the server to the client;
receiving ranged download requests for the file at the server; and
servicing the download requests.

2. The method of claim 1, wherein the server comprises at least two servers.

3. The method of claim 1, further comprising:
receiving, from the client, a byte request to return the size of a specified file before receiving the ranged requests and returning the size of the file to the client.

4. The method of claim 1, wherein the request to download a file in chunks from a client includes a series of download requests for different specified ranges of bytes for the file.

5. The method of claim 1, wherein the DNS returns the IP address of the server with a short time-to-live (TTL), thereby each of the series of sequential requests is processed anew.

6. The method of claim 1, wherein the DNS request is a request for multiple IP addresses.

7. The method of claim 1, wherein the DNS returns a chunk-record comprising a plurality of servers to service a download request.

8. The method of claim 7, wherein the received ranged download requests are received at two or more of the servers returned in the chunk-record.

9. A method for delivering a file in chunks for a Content Delivery Network comprising:
receiving an address request for a named server, from a client, at a domain name service (DNS), the address request requesting an IP address of a named server to service a download of a file in chunks;
returning an address of a web server in the Content Delivery Network;
receiving a download request for the file at the web server of the Content Delivery Network; and
redirecting the download request at the web server of the Content Delivery Network to a series of servers in the Content Delivery Network to return the file in chunks.

10. The method of claim 9, wherein the download request comprises a series of requests comprising byte ranges of a file to be downloaded, each of which are redirected at the web server.

11. A system for networked-based delivery of a file comprising:
at least one CDN server in a Content Delivery Network (CDN) is configured for receiving requests to download a file in segments, wherein the CDN server(s) receive(s) a plurality of requests for a plurality of segments of the file making up the whole file, and further configured for servicing the request by simultaneously sending at least a portion of at least two ranges.

12. The system of claim 11 further comprising:
a domain name service (DNS) server for initially receiving an IP address request from a client and upon receiving the request, determining at least one preferred CDN server to service the request to download and returning the at least one CDN server's IP address to the client.

13. The system of claim 12, wherein the at least one preferred CDN sever comprises more than one CDN server.

14. The system of claim 11, wherein the at least one CDN server is a first CDN server which, when it receives the requests to download the file in segments, is configured to determine for each received request whether a second CDN server is more desirable to service the request, and if the first CDN server determines that the second CDN server is more desirable, the first CDN server is configured to redirect the request to the second CDN server to service the request.

15. The system of claim 12, wherein the DNS server is configured to determine the at least one preferred CDN server to service the download by analyzing at least one factor that is indicative of the efficiency in which the at least one preferred CDN server can service the request.

16. The system of claim 14, wherein the first CDN server determines that the second CDN server is more desirable for servicing the download by analyzing at least one factor that is indicative of the efficiency in which the second CDN server can service the request.

17. The system of claim 16, wherein the at least one factor is availability of the preferred server.

18. The system of claim 16, wherein the at least one factor is workload of the preferred server.

19. The system of claim 16, wherein the at least one factor is network congestion between the client and the preferred end server.

20. The system of claim 16, wherein the at least one factor is proximity to the client to the preferred end server.

21. A device comprising:
a processor configured to make a series of requests to download a range of bytes of a file, collectively the series of requests comprising requests for an entire range of bytes making up the entire file; and
a communications interface configured to receive the series of requests to download from the processor and send them to a Content Delivery Network (CDN) for servicing, and configured to receive from the Content Delivery Network at least a portion of at least two different byte ranges simultaneously.

22. The device of claim 21, wherein the processor is further configured for running a web browser programmed to download a file in a series of ranges of bytes.

23. The device of claim 21, wherein the processor is further configured for accepting a redirect instruction from the CDN and following the redirect instruction to receive the range of bytes from a second server within the CDN network.

24. The device of claim 21, wherein the processor is further configured to execute optimization logic to determine at least one of the following: how many download requests to make simultaneously and from which server should the byte range be requested.

25. A computer program product, comprising a computer-readable medium having a computer-readable program code embodied therein, to implement a method for serving a file in chunks, said method comprising:
receiving a request at a domain name service (DNS) for an IP address of a server to service a file download in chunks from a client;
processing the request to determine at least one server of a Content Delivery Network to service the download;
returning the at least one server to the client;
receiving ranged download requests for the file directly at the at least one server returned by the Content Delivery Network; and
servicing the request.

26. The computer program product of claim 25, wherein the request to download a file in chunks from a client includes a series of sequential requests for different specified ranges of bytes for the file.

27. The computer program product of claim 25, wherein the DNS returns the IP address with a short time-to-live, thereby each of the series of sequential requests is processed anew.

28. A computer program product, comprising a computer-readable medium having a computer readable program code embodied therein, said computer readable program code adapted to be executed to implement a method for downloading a file in chunks, said method comprising:
receiving an IP address request at a domain name service (DNS) for a server to service a download of a file in chunks from a client;
returning a web server address of a server in the Content Delivery Network;
receiving a download request for the file at the web server of the Content Delivery Network; and
redirecting the download request at the web server of the Content Delivery Network to a series of servers in the Content Delivery Network to return the file in chunks.

29. A computer program product, comprising a computer-readable medium having a computer readable program code embodied therein, said computer readable program code adapted to be executed to implement a method for downloading a file in chunks, said method comprising:
requesting a file download from a Content Delivery Network by sending a series of requests to download a range of bytes of a file, the collective series of requests comprising requests for an entire range of bytes making up the entire file; and
receiving from the Content Delivery Network at least a portion of at least two different byte ranges simultaneously.
